(19) United States
(12) Patent Application Publication
(10) Pub. No.: US 2015/0063758 A1
(43) Pub. Date: Mar. 5, 2015

(54) GANG FIBER ADAPTOR WITH INTEGRAL MOUNTING FEATURES

(71) Applicant: Corning Optical Communications LLC, Hickory, NC (US)

(72) Inventors: William Julius McPhil Giraud, Azle, TX (US); Ashley Wesley Jones, Denton, TX (US); Lance Travis Rummel, Fort Worth, TX (US)

(21) Appl. No.: 14/470,329

(22) Filed: Aug. 27, 2014

Related U.S. Application Data
(60) Provisional application No. 61/872,108, filed on Aug. 30, 2013.

(51) Int. Cl. G02B 6/38

(52) U.S. Cl. CPC G02B 6/3834
USPC 385/78; 29/458

(57) ABSTRACT

A gang adaptor assembly that comprises a plurality of adaptors positioned adjacent to one another along a longitudinal axis, each adaptor having a body that includes a pair of opposed short sides and a pair of opposed long sides, the pair of opposed short sides and the pair of opposed long sides defining an axial cavity for each adaptor, wherein the adaptors are oriented adjacent to one another along the longitudinal axis such that the pair of opposed long sides are substantially transverse to the longitudinal axis and the pair of opposed short sides are substantially parallel to the longitudinal axis; at least a portion of a ferrule alignment structure molded within each adaptor and configured to receive a remaining portion of the ferrule alignment structure; and first and second mounting features; wherein the gang adaptor assembly is molded as a single, integral assembly.

### RELATED APPLICATIONS

This application claims the benefit of priority under 35 U.S.C. §119 of U.S. Provisional Application No. 61/872,108 filed on Aug. 30, 2013, the content of which is relied upon and incorporated herein by reference it its entirety.

### BACKGROUND

1. Field of the Disclosure

The disclosure relates generally to optical fiber adaptors, and more particularly to gang optical fiber adaptors or adaptor banks which may be used in fiber optic distribution frames located in structures such as, for example, central offices or fiber optic local convergence points like outdoor cabinets.

2. Technical Background

In fiber optic network apparatus including convergence points and distribution frames there is a constant demand for apparatus permitting high-density distribution with very high fiber termination counts in a small, confined volume. To accomplish the high-density distribution with high fiber termination counts requires efficient utilization of space with due regard to constraints put on fiber optic cables such as minimum bending radii. Optical fiber adaptors or adaptor banks may be used to accomplish the high fiber termination counts in fiber optic distribution frames located in structures such as, for example, central offices or fiber optic local convergence points like outdoor cabinets.

### SUMMARY

One embodiment of the disclosure relates to an adaptor that comprises a body that includes a pair of opposed short sides having a length (l) and a pair of opposed long sides having a length (L). The pair of opposed short sides and the pair of opposed long sides define an axial cavity of the adaptor. A portion of a ferrule alignment structure is molded within the axial cavity and configured to receive a remaining portion of the ferrule alignment structure. The adaptor is molded as a single, integral assembly

An additional embodiment of the disclosure relates to a gang adaptor assembly that comprises a body including a front end, a rear end, a top wall, a bottom wall, a first side wall, and a second side wall. The body also has a plurality of interior side walls disposed between and parallel to the first side wall and the second side wall. The top wall, the bottom wall, the first side wall, the second side wall, and the plurality of interior side walls define a plurality of axial cavities extending from the front end to the rear end of the body, and each of the plurality of axial cavities corresponds to one of a plurality of adaptors. Each of the plurality of adaptors shares at least one of the plurality of interior side walls with an adjacent adaptor. At least a portion of a ferrule alignment structure is molded within each of the plurality of adaptors. The at least a portion of the ferrule alignment structure comprises at least a ferrule holder. The gang adaptor assembly also comprises a first mounting feature that is molded into a face of the first side wall external to the plurality of adaptors, and a second mounting feature molded into a face of the second side wall external to the plurality of adaptors.

An additional embodiment of the disclosure relates to a method of manufacturing a gang adaptor assembly that comprises molding the gang adaptor assembly as a single, integral piece. The gang adaptor assembly comprises a front end, a rear end, a top wall, a bottom wall, a first side wall, a second side wall, and a plurality of interior side walls disposed between and parallel to the first side wall and the second side wall. The top wall, the bottom wall, the first side wall, the second side wall, and the plurality of interior side walls define a plurality of axial cavities that extend from the front end to the rear end of the body, and each of the plurality of axial cavities correspond to one of a plurality of adaptors. A portion of a ferrule alignment structure is molded within each of the plurality of adaptors. Additionally, a set of mounting features extends from the first and second side walls to connect the gang adaptor assembly to a cassette. The method also includes inserting a remaining portion of the ferrule alignment structure into each of the plurality of adaptors. The remaining portion of the ferrule alignment structure is configured to snap into each of the plurality of adaptors.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely illustrative, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a right front perspective view of a gang adaptor assembly according to one or more embodiments shown or described herein;

FIG. 2 is a right front perspective view of a gang adaptor assembly having a different set of mounting features according to one or more embodiments shown or described herein;

FIG. 3 is a right front perspective view of a gang adaptor assembly having yet a different set of mounting features according to one or more embodiments shown or described herein;

FIG. 4 is a left rear perspective view of the gang adaptor assembly of FIG. 1 according to one or more embodiments shown or described herein;

FIG. 5 is a right front perspective view of the gang adaptor assembly of FIG. 1 connected to a optical fiber cassette according to one or more embodiments shown or described herein;

FIG. 6 is an exploded view of a ferrule alignment structure to be inserted into each adaptor in the gang adaptor assembly according to one or more embodiments shown or described herein;

FIG. 7 is a detail of a right front perspective view of a second end of the gang adaptor assembly of FIG. 1 according to one or more embodiments shown or described herein; and

FIG. 8 is a right front perspective cross-sectional view of the adaptor of the gang adaptor assembly of FIG. 7 shown along line 8-8 according to one or more embodiments shown or described herein.

### DETAILED DESCRIPTION

Various embodiments will be further clarified by the following examples.

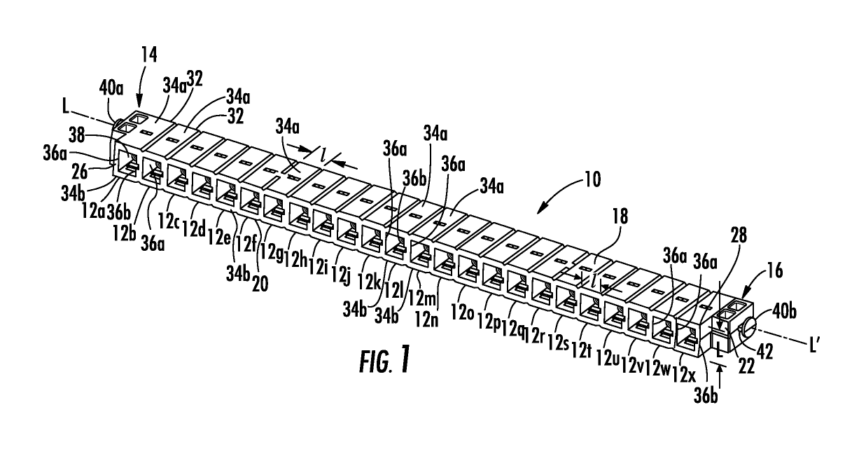

Referring to FIGS. 1-4, an example of a gang adaptor assembly is shown as 10. Gang adaptor assembly 10 includes twenty-four (24) adaptors 12a-12x connected together. Gang adaptor assembly 10 includes a first end 14 and a second end 16 opposite first end 14 along a longitudinal axis L-L′. Gang adaptor assembly 10 also includes a top wall 18 extending between first and second ends 14 and 16, respectively, a bottom wall 20 extending between first and second ends 14 and 16, respectively, on a side of gang adaptor assembly 10 opposite top wall 18, a front end 22 extending between first and second ends 14 and 16, respectively, and a rear end 24, extending between first and second ends 14 and 16, respectively, on a side of gang adaptor assembly 10 opposite front end 22. First end 14 includes a first side wall 26 and second end 16 includes a second side wall 28. First and second side walls 26 and 28 extend between top wall 18 and bottom wall 20 and between front end 22 and rear end 24. Similarly, a plurality of interior side walls 30 are disposed between and parallel to first and second side walls 26 and 28, extending between top wall 18 and bottom wall 20 and between front end 22 and rear end 24.

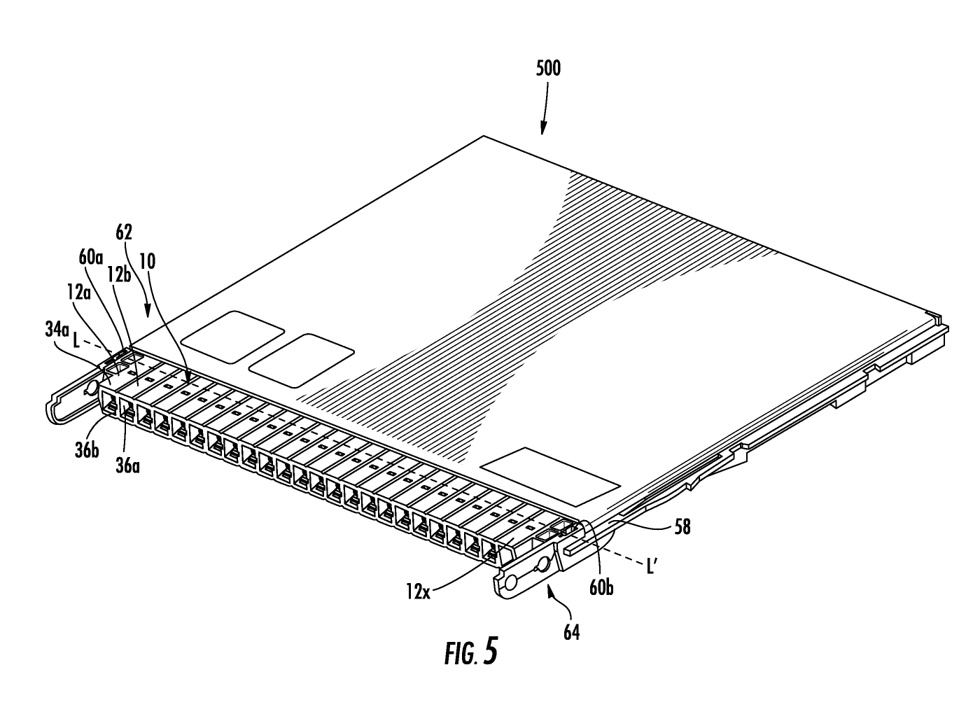

Each adaptor 12a-12x is configured to receive an individual optical fiber by conventional methods. Adaptors 12a-12x may receive any conventional optical fiber connector for connecting to optical fibers such as, for example, SC connectors, LC connectors, ST connectors, FC connectors, E2000 connectors, and any other optical fiber connectors. As shown in this example, adaptors 12a-12x are configured to receive SC connectors. However, in the embodiment shown, the adaptors 12a-12x are aligned so that the long sides of adjacent adaptors interface. In this manner, more adaptors can be ganged in a certain length such that gang adaptor assembly 10 permits 24 adaptors to be ganged together in one optical fiber cassette 500 as shown in FIG. 5.

In this regard, adaptors 12a-12x each have a body 32, wherein body 32 includes a first short side 34a, a second short side 34b opposite first short side 34a, a first long side 36a, a second long side 36b opposite first long side 36a, and an axial cavity 38 disposed through body 32 between the four walls. In various embodiments, the first short side 34a for each of the adaptors 12a-12x is connected as top wall 18 from which each of the long sides (including first long side 36a and second long side 36b) extend. Similarly, the second short side 34b for each of the adaptors 12a-12x is connected as bottom wall 20 from which each of the long sides extend. Thus, the long sides (e.g., first side wall 26, second side wall 28, and plurality of interior side walls 30) interface to divide the top and bottom walls into the first and second short sides 34a and 34b to define the body 32 for each of the adaptors 12a-12x. Axial cavity 38 is configured and operable to receive and connect to an optical fiber inserted therein. First and second short sides 34a and 34b, respectively, have a length (l), and first and second long sides 36a and 36b, respectively, have a length (L). Length (L) is greater than length (l).

Adaptors 12a-12x are disposed side-by-side along longitudinal axis L-L′ to form gang adaptor assembly 10. As shown, the adaptors 12a-12x are positioned such that the adaptor's long sides are adjacent to each other or connected to each other and are transverse to longitudinal axis L-L′. In this configuration, first and second short sides 34a and 34b, respectively, are parallel to longitudinal axis L-L′. For example, a second long side 36b of first adaptor 12a is positioned adjacent to first long side 36a of second adaptor 12b. This configuration permits a dense adaptor configuration on the optical fiber cassette 500 such as shown, for example, in FIG. 5. In various embodiments, each of the adaptors may share at least one long side with an adjacent adaptor. For example, a second long side 36b of first adaptor 12a may be the same interior side wall 30 that is first long side 36a of second adaptor 12b. This configuration may also permit a dense adaptor configuration on the optical fiber cassette 500. In other embodiments, each adaptor may include at least one connecting feature configured to connect the adaptor to another, adjacent adaptor. Adaptors may be connected using any conventional or yet-to-be developed connecting features, including but not limited to snap-fit connections. The connecting features may be located on opposing long sides or on opposing short sides of the adaptors, depending on the particular implementation. Some adaptors may include a pair of connecting features, one on each opposing long sides, while other adaptors may include a single connecting features, such as on one of the opposing long sides, and a mounting feature (e.g., a mounting feature configured to connect the adaptor to a cassette or other device within fiber optic distribution frames), such as on the other opposing long side. Still other adaptors may include a pair of mounting features, one on each opposing long side.

As shown in FIGS. 1-3, the gang adaptor assembly 10 can include a set of mounting features extending from the first side wall 26 and the second side wall 28. The mounting features can enable the gang adaptor assembly 10 to connect to optical fiber cassette 500, a rack-mount housing, or a fiber distribution hub (FDH) cabinet. The mounting features illustrated in FIG. 1 enable the gang adaptor assembly 10 to connect to the optical fiber cassette 500 and is shown and described in copending, commonly owned U.S. Provisional Patent Application Ser. No. 61/825,779, filed May 21, 2013, which is hereby incorporated by reference in its entirety. In particular, a stem (not shown) extends from a face of the first side wall 26 external to the adaptors 12a-12x of gang adaptor assembly 10, along longitudinal axis L-L′, and a head 40a is positioned on a distal end of the stem and extends transverse to the stem and longitudinal axis L-L′. Also, a stem 42 extends from a face of the second side wall 28 external to the adaptors 12a-12x of gang adaptor assembly 10 along longitudinal axis L-L′, opposite first side wall 26. A head 40b is positioned on a distal end of stem 42 and extends transverse to stem 42 and the longitudinal axis. It is understood that the stem and head 40a extending from first side wall 26 is the same as or similar to stem 42 and head 40a. In this example, gang adaptor assembly 10 is molded as an integral piece from a polymer material, composite material, or any combination thereof. An example of a polymer material that may be used is polycarbonate, UItem. However, it is understood that gang adaptor assembly 10 may be manufactured from one or more pieces that may be connected together using conventional methods such as for example, welding (e.g., hot weld, sonic welds, etc.), snap-fit connections, screws, bolt and nut connections, etc.

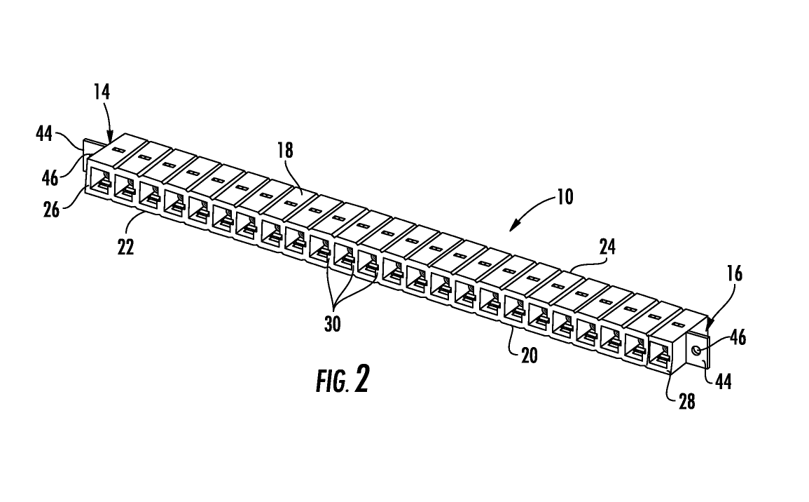

The mounting features illustrated in FIG. 2 enable the gang adaptor assembly 10 to connect to a rack-mount housing. As in FIG. 1, the gang adaptor assembly 10 depicted in FIG. 2 includes a first end 14, a second end 16, a top wall 18, a bottom wall 20, a front end 22, and a rear end 24. Gang adaptor assembly 10 also includes a plurality of interior side walls 30 disposed between and parallel to the first side wall 26 and the second side wall 28. A plate 44 extends from a face of each of the first side wall 26 and the second side wall 28 external to the adaptors 12a-12x. Each plate 44 includes a mounting hole 46 configured to receive a fastener, such as a pin, screw, or the like, to secure the gang adaptor assembly 10 to the rack-mount housing. It is understood that the mounting hole 46 may be a substantially round hole, as depicted in FIG. 2, or the mounting hole 46 may have an oval or other shape. As illustrated in FIG. 2, each plate 44 extends from the respective first and second side wall 26 and 28 such that the mounting hole 46 extends from the front end 22 to the rear end 24, parallel to the axial cavity 38 of each adaptor 12a-12x. However, in some embodiments, the mounting hole 46 may be oriented in other directions, such as perpendicular to the axial cavity 38 of each adaptor 12a-12x. The orientation and shape of the mounting hole 46 may vary depending on the particular embodiment. In this example, gang adaptor assembly 10 is molded with the mounting features as an integral piece from a polymer material, composite material, or any combination thereof. An example of a polymer material that may be used is polycarbonate, UItem. However, it is understood that gang adaptor assembly 10 may be manufactured from one or more pieces that may be connected together using conventional methods such as for example, welding (e.g., hot weld, sonic welds, etc.), snap-fit connections, screws, bolt and nut connections, etc.

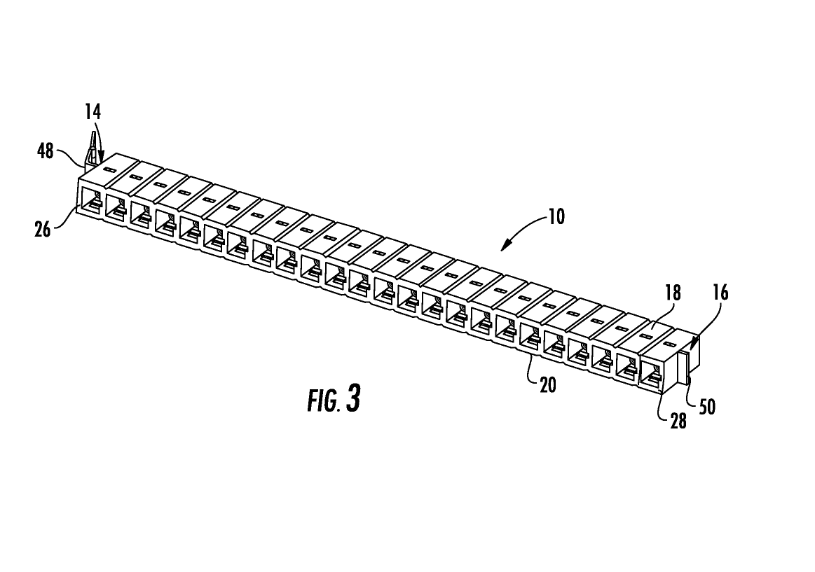

FIG. 3 schematically depicts a gang adaptor assembly 10 that includes integrally molded mounting features to enable the gang adaptor assembly 10 to be mounted within a fiber distribution hub (FDH) cabinet. As shown in FIG. 3, first end 14 of gang adaptor assembly 10 includes a latch 48 while second end 16 of gang adaptor assembly includes a tab 50. The latch 48 is designed to removably snap into an opening in a bracket, panel, or other suitable mounting structure, of the FDH cabinet while the tab 50 is engaged in a corresponding opening in the storage panel for a mounting location within the FDH cabinet. Although FIGS. 1-3 depict mounting features for connecting the gang adaptor assembly 10 to optical fiber cassette 500, a rack-mount housing, and an FDH cabinet, other mounting features may be integrally molded as part of the gang adaptor assembly 10. Thus, the gang adaptor assembly 10 may be mounted in, on or to any type of frame, structure or housing.

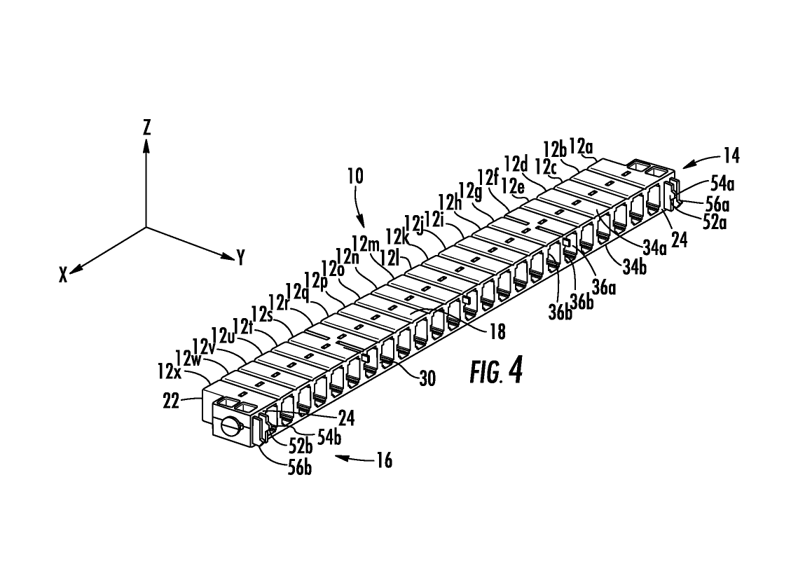

Referring to FIG. 4, gang adaptor assembly 10 may include a first latch actuator 52a at first end 14 and a second latch actuator 52b at second end 16. First and second latch actuators 52a and 52b include actuator surfaces 54a and 54b which correspond with and engage corresponding latch engagement surfaces on latch mechanisms located on an optical fiber cassette 500. In this example, actuator surfaces 54a and 54b are arcuate or curved surfaces and the corresponding latch surfaces on the first and second latch mechanisms comprise shapes that correspond to (i.e., are the inverse of) the actuator surfaces 54a and 54b. However, it is understood that actuator surfaces 54a and 54b may comprise any shape, configuration, angle, or radius of curvature as long as such surface actuates the corresponding latch mechanism to release the adaptor holder or gang adaptor assembly such that it may rotate or tilt within optical fiber cassette 500 as will be shown and described below herein. In one such alternative example, actuator surfaces 54a and 54b may be linear, angled surfaces that engage corresponding linear, angled surfaces of the first and second latch mechanisms on optical fiber cassette 500.

Also, gang adaptor assembly 10 may include a first stop 56a or a second stop 56b disposed along rear end 24 at respective first and second ends 14 and 16. First stop 56a or second stop 56b may be configured to prevent gang adaptor assembly 10 from rotating or tilting beyond a specific angular rotation, angle a, about longitudinal axis L-L′. In this example, first stop 56a and second stop 56b each comprise a stop oriented at an angle α. First and second stop 56a and 56b are configured to prevent gang adaptor assembly 10 from rotating or tilting past angle a (not shown). Angle a is determined based upon the desired maximum angle of rotation or tilt of gang adaptor assembly 10 about longitudinal axis L-L′.

In certain examples, angle a is about 10°, about 15°, about 20°, about 25°, about 30°, about 35°, about 40°, about 45°, about 50°, about 55°, about 60°, about 65°, about 70°, about 75°, about 80°, about 85°, or about 90°. In such embodiment, gang adaptor assembly 10 may rotate or tilt between a starting position angular orientation (e.g.,0°) and angle α. In other embodiments gang adaptor assembly 10 may be configured to rotate or tilt 360° about axis L-L′.

As shown in FIG. 5, gang adaptor assembly 10 may be fixedly, movably, or removably connected to a framework 58 of optical fiber cassette 500 as will be explained below herein. In this example, gang adaptor assembly 10 is rotatably connected to framework 58 such that gang adaptor assembly 10 may rotate or tilt about longitudinal axis L-L′ in a counterclockwise direction or clockwise direction. In addition, optical fiber cassette 500 may be configured to be removably inserted into or mounted to a tray, frame, chassis, housing, enclosure, rack or any other structure as conventionally known.

Optical fiber cassette 500 includes a framework 58 operable for receiving, routing, managing and storing optical fibers, optical fiber connections and optical components. Optical fiber cassette 500 is operable to slide into and out of a fiber optic distribution frames or cabinets. Framework 58 includes a first head slot 60a disposed within framework 58 at a first framework side 62 of framework 58 to receive head 40a and stem (not sown) located on first end 14 of gang adaptor assembly 10. Additionally, framework 58 includes a second head slot 60b disposed within framework 58 at a second framework side 64 of framework 58 to receive head 40b and stem 42 located on second end 16 of gang adaptor assembly 10. The above described connection points between the gang adaptor assembly 10 and optical fiber cassette 500 permit gang adaptor assembly 10 to rotate or tilt in a counter-clockwise direction or a clockwise direction about an axis L-L′ such as, for example, those shown and described in copending, commonly owned U.S. Provisional Patent Application Ser. No. 61/825,779, filed May 21, 2013, which is hereby incorporated by reference in its entirety.

In the example shown in FIGS. 1-5, gang adaptor assembly 10 includes 24 adaptors 12a-12x for receiving SC connectors. However, a variety of designs, adaptors and configurations may be used with the rotatable connection as shown and described herein. As such, any type and number of adaptors may be ganged and connected to a cassette such as, for example, those shown and described in copending, commonly owned U.S. Provisional Patent Application Ser. No. 61/825,779, filed May 21, 2013, which is hereby incorporated by reference in its entirety.

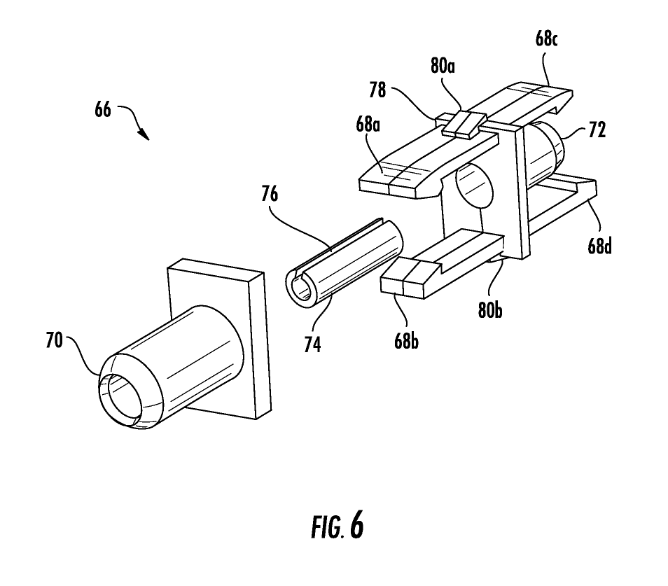

Each adaptor 12a-12x further includes a ferrule alignment structure 66, shown in FIG. 6. In the embodiment shown in FIG. 6, ferrule alignment structure 66 includes four flexible arms 68a, 68b, 68c, and 68d that flex to enable ferrule alignment structure 66 to be inserted into an axial cavity 38 of one of the adaptors 12a-12x. Ferrule alignment structure 66 also includes a first ferrule holder 70 and a second ferrule holder 72. First and second ferrule holders 70 and 72 form a mounting sleeve that is configured to receive a ferrule sleeve 74 into which ferrules are inserted. In various embodiments, ferrule sleeve 74 includes a slit 76 for allowing ferrule sleeve 74 to compress and reduce its diameter during insertion into the ferrule alignment structure. Ferrule sleeve 74 may be inserted into the mounting sleeve through either first ferrule holder 70 or second ferrule holder 72.

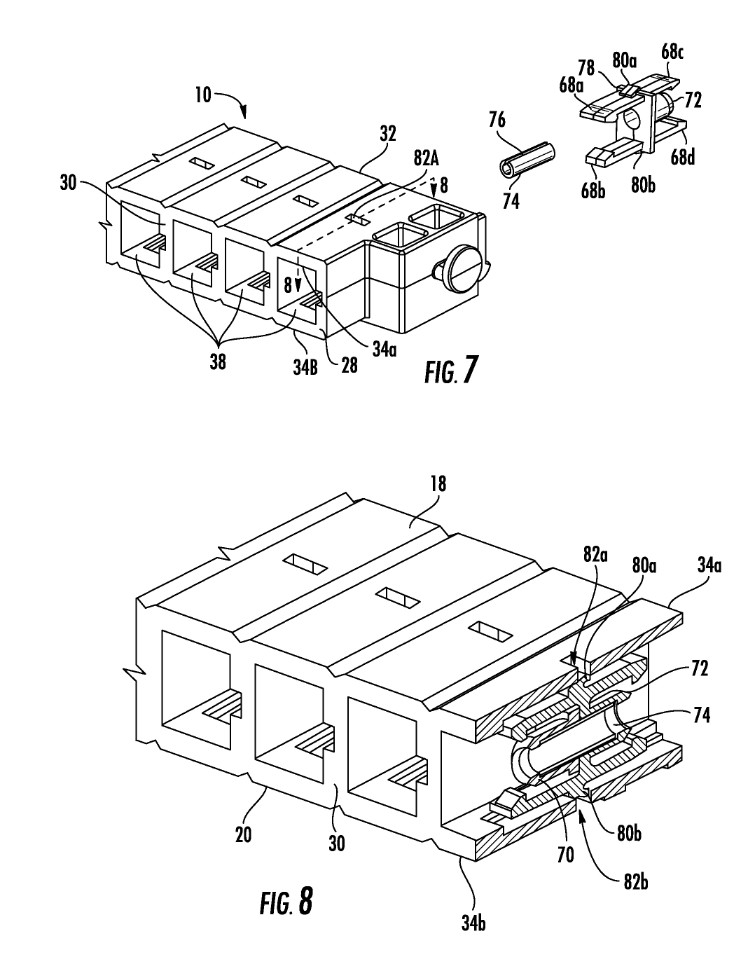

In various embodiments, at least a portion of the ferrule alignment structure 66 is molded within the axial cavity 38 as an integral piece of each of the adaptors 12a-12x. FIGS. 7-8 schematically depict a number of the adaptors 12a-12x of the gang adaptor assembly 10 of FIGS. 1-5 in greater detail. As shown in FIG. 7, the adaptors 12a-12x each have an axial cavity 38 disposed through body 32 between the four walls as shown and described above. In various embodiments, at least a portion of a ferrule alignment structure 66 is molded within the axial cavity 38 of each adaptor 12a-12x, shown in the cross-sectional view of the axial cavity 38 schematically depicted in FIG. 8. For example, as shown in FIG. 8, first ferrule holder 70 is molded within the axial cavity 38 of each adaptor 12a-12x. Though first ferrule holder 70 is illustrated as being molded within axial cavity 38, additional or alternative portions of the ferrule alignment structure 66 may be molded within the axial cavity 38. In various embodiments, less than the whole ferrule alignment structure 66 is molded within the axial cavity 38, although in some embodiments, the whole ferrule alignment structure 66 may be molded within the axial cavity 38.

When a portion of the ferrule alignment structure 66 is molded within the axial cavity 38, the axial cavity 38 is further molded such that it is configured to receive the remaining portion 78 of the ferrule alignment structure 66, including the second ferrule holder 72. The axial cavity 38, and the portion of the ferrule alignment structure 66 molded therein, may be configured to receive the remaining portion 78 of the ferrule alignment structure 66 in a snap-fit connection. When the remaining portion 78 of the ferrule alignment structure 66 is inserted into the axial cavity 38, tabs 80a and 80b on the exterior sides between flexible arms 68a and 68c and 68b and 68d, respectively, are pushed inwardly by the first short side 34a and second short side 34b of body 32, permitting the remaining portion 78 of the ferrule alignment structure 66 to slide into the axial cavity 38. Once the tabs 80a and 80b reach the channels 82a and 82b disposed within the first short side 34a and the second short side 34b respectively, the tabs 80a and 80b move, flex, or snap back outwardly into the channels 82a and 82b. When tabs 80a and 80b are within respective channels 82a and 82b, the remaining portion 78 of the ferrule alignment structure 66 is locked into its position within the axial cavity 38. As such, the remaining portion 78 is connected to, locked into, or “snapped” into axial cavity 38.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An adaptor for receiving a fiber optic connector, the adaptor comprising:
a body that includes a first pair of opposed sides and a second pair of opposed sides disposed perpendicular to the first pair of opposed sides, the first pair of opposed sides and the second pair of opposed sides defining an axial cavity disposed between the first and second pair of opposed sides; and
a portion of a ferrule alignment structure molded within the axial cavity and configured to receive a remaining portion of the ferrule alignment structure;
wherein the adaptor is molded as a single, integral assembly.

2. The adaptor of claim 1, wherein the portion of the ferrule alignment structure molded within the axial cavity is configured to receive the remaining portion of the ferrule alignment structure via a snap-fit connection.

3. The adaptor of claim 1, wherein the portion of the ferrule alignment structure molded within the axial cavity comprises a ferrule holder.

4. The adaptor of claim 3, wherein the remaining portion of the ferrule alignment structure comprises a second ferrule holder.

5. The adaptor of claim 1, further comprising at least one mounting feature disposed on one of the pair of opposed long sides, the at least one mounting feature configured to connect the adaptor to one of a cassette, a rack-mount housing, or a fiber distribution hub cabinet.

6. The adaptor of claim 1, further comprising at least one connecting feature disposed on one of the pair of opposed long sides, the at least one connecting feature configured to connect the adaptor to a second adaptor.

7. A gang adaptor assembly comprising:
a body including a front end, a rear end, a top wall, a bottom wall, a first side wall, and a second side wall, the body having a plurality of interior side walls disposed between and parallel to the first side wall and the second side wall;
wherein the top wall, the bottom wall, the first side wall, the second side wall, and the plurality of interior side walls define a plurality of axial cavities extending from the front end to the rear end of the body, each of the plurality of axial cavities corresponding to one of a plurality of adaptors, each of the plurality of adaptors sharing at least one of the plurality of interior side walls with an adjacent adaptor;
at least a portion of a ferrule alignment structure molded within each of the plurality of adaptors, wherein the at least a portion of the ferrule alignment structure comprises at least a ferrule holder;
a first mounting feature molded into a face of the first side wall, wherein the face of the first side wall is external to the plurality of adaptors; and
a second mounting feature molded into a face of the second side wall, wherein the face of the second side wall is external to the plurality of adaptors.

8. The gang adaptor assembly of claim 7, wherein the at least a portion of the ferrule alignment structure molded within each of the plurality of adaptors is configured to receive a remaining portion of the ferrule alignment structure in a snap-fit connection.

9. The gang adaptor assembly of claim 7, wherein the plurality of adaptors comprises 24 adaptors.

10. The gang adaptor assembly of claim 7, wherein the first and second mounting features connect the gang adaptor assembly to a cassette.

11. The gang adaptor assembly of claim 7, wherein the first and second mounting features connect the gang adaptor assembly to a rack-mount housing.

12. The gang adaptor assembly of claim 7, wherein the first and second mounting features connect the gang adaptor assembly to a fiber distribution hub cabinet.

13. The gang adaptor assembly of claim 7, wherein the gang adaptor assembly is molded as a single, integral piece.

14. The gang adaptor assembly of claim 13, wherein the at least a portion of the ferrule alignment structure molded within each of the plurality of adaptors is configured to receive a remaining portion of the ferrule alignment structure in a snap-fit connection.

15. A method of manufacturing a gang adaptor assembly comprising:
molding the gang adaptor assembly as a single, integral piece, the gang adaptor assembly comprising:
a front end, a rear end, a top wall, a bottom wall, a first side wall, a second side wall, and a plurality of interior side walls disposed between and parallel to the first side wall and the second side wall;
wherein the top wall, the bottom wall, the first side wall, the second side wall, and the plurality of interior side walls define a plurality of axial cavities extending from the front end to the rear end, each of the plurality of axial cavities corresponding to one of a plurality of adaptors;
a portion of a ferrule alignment structure molded within each of the plurality of adaptors; and
a set of mounting features extending from the first and second side walls to connect the gang adaptor assembly to a cassette; and
inserting a remaining portion of the ferrule alignment structure into each of the plurality of adaptors, wherein the remaining portion of the ferrule alignment structure is configured to snap into each of the plurality of adaptors.

16. The method of claim 15, wherein the plurality of adaptors comprises 24 adaptors.

17. The method of claim 15, wherein each of the first side wall, second side wall, and plurality of interior side walls has a length (L), wherein each of the plurality of interior side walls are spaced apart from an adjacent one of the plurality of interior side walls by a length (l), wherein the length (L) is greater than the length (l).

18. The method of claim 15, wherein molding the gang adaptor assembly comprises molding the gang adaptor assembly from a polymer material, a composite material, or a combination thereof.

19. The method of claim 15, wherein the portion of the ferrule alignment structure molded within each of the plurality of adaptors comprises a ferrule holder.

20. The method of claim 19, the ferrule holder of the portion of the ferrule alignment structure being a first ferrule holder, wherein the remaining portion of the ferrule alignment structure comprises a second ferrule holder.
